(19) United States
(12) Patent Application Publication
(10) Pub. No.: US 2021/0260584 A1
(43) Pub. Date: Aug. 26, 2021

(54) MICROFLUIDIC DEVICES AND USES THEREOF

(71) Applicant: Signal Biosystems, Inc., San Mateo, CA (US)

(72) Inventor: Jeffrey LIN, Palo Alto, CA (US)

(21) Appl. No.: 17/167,949

(22) Filed: Feb. 4, 2021

Related U.S. Application Data
(63) Continuation of application No. PCT/US2019/045103, filed on Aug. 5, 2019.
(60) Provisional application No. 62/715,136, filed on Aug. 6, 2018.

(51) Int. Cl. B01L 3/00

(52) U.S. Cl. CPC B01L 3/502738; B01L 2400/0655; B01L 2400/0622

(57) ABSTRACT

The present disclosure provides microfluidic device comprising microfluidic valves with low or substantially no dead volume. The valves may comprise an actuation layer, a fluidic layer and a membrane between the actuation layer and the fluidic layer. The fluidic layer may comprise a fluidic channel, which fluidic channel may have a cross-sectional area having a curved shape. The actuation layer may be configured to apply positive or negative pressure to the membrane to deflect the membrane towards or away from the fluidic layer. The membrane may comprise one or more polymeric layers.

### CROSS-REFERENCE

This application is a continuation of International Patent Application No. PCT/US2019/045103, filed on Aug. 5, 2019, which claims the benefit of U.S. Provisional Patent Application No. 62/715,136, filed on Aug. 6, 2018, the contents of each are incorporated herein by reference in their entirety for all purposes.

### BACKGROUND

Microfluidic technology can have many benefits for research, such as automation, minimal reagent use, and parallelization, all of which may lead to enormous gains in cost-reduction and scalability. Microfluidic devices and systems may provide improved methods of performing chemical, biochemical and biological analysis and synthesis. Microfluidic devices and systems may allow for the performance of multi-step, multi-species chemical, biochemical and biological operations.

### SUMMARY

Current microfluidic devices may be for one-time use. For example, after each experimental run, a microfluidic chip is discarded and a new one is used for subsequent runs to avoid cross-contamination of reagents between sample runs. This may increase costs of performing chemical, biochemical and biological analysis and synthesis using microfluidic technologies and become a major barrier to automation and scalability of microfluidic technologies and devices. Thus, recognized herein is the need for reusable microfluidic devices.

In some cases, the microfluidic devices are made from materials that are biocompatible. Such materials may resist contamination/sequestering of samples and/or reagents (e.g., chemical, biological, biomedical samples and/or reagents). In some cases, the materials are flexible enough to form various components of a microfluidic device, e.g., pneumatically actuated valves. Proper valve geometry on a microfluidic device may provide desired flexibility of the materials or minimize cross-contamination of samples/reagents among separate runs.

An aspect of the present disclosure provides a microfluidic device comprising: a fluidic channel; and a valve in fluidic communication with the fluidic channel, wherein the valve comprises (i) a pneumatic layer configured to supply a positive or negative pressure, (ii) a fluidic layer having no perpendicular sides, and (iii) a membrane sandwiched between the pneumatic layer and the fluidic layer, wherein the pneumatic layer is configured to apply the positive or negative pressure to the membrane to deflect the membrane towards or away from the fluidic layer, to thereby subject fluid to movement to or from the fluidic channel.

In some embodiments, the fluidic channel of the valve does not have perpendicular sides. In some embodiments, cross-sectional shape of the fluidic layer is a non-rectangular shape. In some embodiments, the cross-sectional shape comprises a curved shape. In some embodiments, the curved shape is a regular shape. In some embodiments, the curved shape is an irregular shape. In some embodiments, the curved shape is symmetrical. In some embodiments, the curved shape is asymmetrical. In some embodiments, the curved shape comprises a semi-circular shape, a semi-elliptical shape, a parabolic shape, or a hyperbolic shape. In some embodiments, the pneumatic layer, the fluidic layer and the membrane comprise different materials. In some embodiments, the pneumatic layer, the fluidic layer and the membrane comprise the same materials. In some embodiments, the pneumatic layer, the fluidic layer and/or the membrane are made from materials comprising fluorinated ethylene propylene (FEP), perfluoroalkoxy alkane (PFA), a copolymer of hexafluoropropylene and tetrafluoroethylene, polydimethylsiloxane (PDMS), or combinations thereof. In some embodiments, the pneumatic layer has a width greater than a width of the fluidic layer. In some embodiments, the fluidic layer comprises the fluidic channel. In some embodiments, the fluidic layer has a depth between about 1 micron (μm) and about 1,000 μm. In some embodiments, the depth is greater than 10 μm. In some embodiments, the fluidic layer has a width that is at least about 5 times the depth. In some embodiments, the width is about 5-50 times the depth. In some embodiments, the membrane has a thickness between about 5 μm and about 200 μm. In some embodiments, the thickness is between about 10 μm and about 30 μm. In some embodiments, the fluidic layer comprises a plurality of fluidic channels operable to provide a path for fluid flow through the fluidic layer. In some embodiments, the pneumatic layer comprises a pneumatic channel. In some embodiments, the pneumatic layer comprises a plurality of pneumatic channels. In some embodiments, the microfluidic device comprises a plurality of valves. In some embodiments, the plurality of valves comprises zero dead-volume valves. In some embodiments, the plurality of valves is actuated upon application of the positive or negative pressure to the plurality of pneumatic channels. In some embodiments, the negative pressure is vacuum. In some embodiments, the positive or negative pressure is from a single pressure source. In some embodiments, the valve remains open in the absence of the application of the positive or negative pressure to the plurality of pneumatic channels. In some embodiments, each of the plurality of valves is independently actuated by a different pneumatic channel. In some embodiments, the plurality of valves is actuated in a pre-defined sequence to regulate a fluid flow through the fluidic channel. In some embodiments, the microfluidic device is monolithic. In some embodiments, the microfluidic device is reusable.

Another aspect of the present disclosure provides a method for directing a fluid flow, comprising: (a) providing a microfluidic device comprising a fluidic channel, and a valve in fluidic communication with the fluidic channel, wherein the valve comprises (i) a pneumatic layer configured to supply a positive or negative pressure, (ii) a fluidic layer having no perpendicular sides, and (iii) a membrane sandwiched between the pneumatic layer and the fluidic layer; and (b) applying the positive or negative pressure from the pneumatic layer to the membrane to deflect the membrane towards or away from the fluidic layer, thereby subjecting fluid to movement to or from the fluidic channel.

Another aspect of the present disclosure provides a microfluidic device comprising: a fluidic channel; and a valve in fluidic communication with the fluidic channel, wherein the valve comprises (i) a pneumatic layer configured to supply a positive or negative pressure, (ii) a fluidic layer coupled to a support, wherein the fluidic layer comprises a surface that is oriented at an angle of less than 90° relative to a plane parallel to the support, and (iii) a membrane sandwiched between the pneumatic layer and the fluidic layer, wherein the membrane is configured to actuate upon application of the positive or negative pressure from the pneumatic layer, wherein upon actuation, the membrane is deflected towards or away from the fluidic layer, to thereby subject fluid to movement to or from the fluidic channel.

Another aspect of the present disclosure provides a method for directing a fluid flow, comprising: (a) providing a microfluidic device comprising a fluidic channel, and a valve in fluidic communication with the fluidic channel, wherein the valve comprises (i) a pneumatic layer configured to supply a positive or negative pressure, (ii) a fluidic layer coupled to a support, wherein the fluidic layer comprises a surface that is oriented at an angle of less than 90° relative to a plane parallel to the support, and (iii) a membrane sandwiched between the pneumatic layer and the fluidic layer; and (b) applying the positive or negative pressure from the pneumatic layer to the membrane to deflect the membrane towards or away from the fluidic layer, thereby subjecting fluid to movement to or from the fluidic channel.

Another aspect of the present disclosure provides a microfluidic device comprising: a fluidic channel; and a valve in fluidic communication with the fluidic channel, wherein the valve comprises (i) a pneumatic layer configured to supply a positive or negative pressure, (ii) a fluidic layer, and (iii) a membrane sandwiched between the pneumatic layer and the fluidic layer; wherein the valve is actuable between an open condition and a closed condition upon application of the positive or negative pressure from the pneumatic layer to the membrane, wherein upon a change of the valve from the open condition to the closed condition, the membrane moves from a first position to a second position relative to the fluidic layer and along a direction perpendicular to a plane of the fluidic layer of the valve to expel substantially all fluid contained in the fluidic layer, thereby regulating a fluid flow in the fluidic channel.

In some embodiments, the pneumatic layer further comprises a pneumatic channel. In some embodiments, the valve is actuated upon application of the positive or negative pressure via the pneumatic channel. In some embodiments, the negative pressure is vacuum. In some embodiments, the valve is a plurality of valves. In some embodiments, each of the plurality of valves is independently actuated by a different pneumatic channel. In some embodiments, each of the plurality of valves is actuable between an open condition and a closed condition. In some embodiments, the plurality of valves is actuated in a pre-defined sequence to regulate a fluid flow through the fluidic layer. In some embodiments, the fluidic layer comprises the fluidic channel. In some embodiments, the fluidic layer comprises a plurality of fluidic channels. In some embodiments, a fluidic flow in each of the plurality of fluidic channels is regulated by a given subset of the plurality of valves. In some embodiments, a fluidic flow in each of the plurality of fluidic channels is independently regulated.

Another aspect of the present disclosure provides a method for regulating a fluid flow, the method comprising: (a) providing a microfluidic device comprising a fluidic channel, and a valve in fluidic communication with the fluidic channel, wherein the valve comprises (i) a pneumatic layer configured to supply a positive or negative pressure, (ii) a fluidic layer, and (iii) a membrane sandwiched between the pneumatic layer and the fluidic layer, wherein the valve is actuable between an open condition and a closed condition upon application of the positive or negative pressure from the pneumatic layer to the membrane; and (b) applying the positive or negative pressure from the pneumatic layer to the membrane to actuate the valve from the open condition to the closed condition, wherein upon actuation, the membrane moves from a first position to a second position relative to the fluidic layer and along a direction perpendicular to a plane of the fluidic layer to expel substantially all fluid contained in the fluidic layer, thereby regulating a fluid flow in the fluidic channel.

Another aspect of the present disclosure provides a microfluidic device comprising a valve comprising an actuation layer, a fluidic layer in fluid communication with a fluidic channel, and a membrane between said actuation layer and said fluidic layer, wherein said membrane can comprise at least two polymeric layers, wherein said actuation layer is configured to actuate said membrane to cause said membrane to move towards or away from a surface of said fluidic layer, wherein when said membrane is disposed away from said surface, said valve is configured to permit fluid flow through said fluidic channel, and when said membrane is in contact with said surface, said valve is configured to impede fluid flow in said fluidic channel. The microfluidic device can further comprise a chip comprising said valve and said fluidic channel. The plurality of fluidic channels can comprise said fluidic channel. The actuation layer may be configured to actuate said membrane by supplying a positive or negative pressure to said membrane. The fluidic layer of the valve may not have perpendicular sides. At least two polymeric layers can be formed of different polymeric materials. The membrane can comprise a first polymeric layer formed of polydimethylsiloxane (PDMS) and a second polymeric layer formed of fluorinated ethylene propylene (FEP). The fluidic channel can have a depth of more than 10 micrometer (um) to 300 um. The fluidic channel can have a width that is at least 2 times a depth of said fluidic channel. The width can be at least 5 times, at least 10 times, at least 15 times, or at least 20 times said depth. The channel width can be at most 20 times, at most 15 times, at most 10 times, at most 5 times, or at most 2 times a channel depth.

Another aspect of the present disclosure provides a method for constructing a microfluidic device, comprising: (a) providing at least two polymeric layers; and (b) disposing said at least two polymeric layers between an actuation layer and a fluidic layer in fluid communication with a fluidic channel, to form a valve comprising a membrane having said at least two polymeric layers as part of said microfluidic device. In some cases, said at least two polymeric layers can be attached to one another. In other cases, said at least two polymeric layers are separated from one another.

Another aspect of the present disclosure provides a method for operating a microfluidic device, comprising: (a) a valve comprising an actuation layer, a fluidic layer in fluid communication with a fluidic channel, and a membrane between said actuation layer and said fluidic layer, wherein said membrane can comprise at least two polymeric layers; and (b) actuating said membrane to cause said membrane to move towards or away from a surface of said fluidic layer, to permit fluid flow through said fluidic channel when said membrane is disposed away from said surface, or impede fluid flow in said fluidic channel when said membrane is in contact with said surface. The actuating can comprise supplying positive or negative pressure to said membrane.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Another aspect of the present disclosure provides a system comprising one or more computer processors, coupled computer memory, and sensors. The sensors provide data that, upon reading by the one or more computer processors, may change the execution path of the executable code that implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A schematically illustrates a sample microfluidic valve;

FIG. 1B schematically illustrates a sample microfluidic valve in an open configuration;

FIG. 1C schematically illustrates a sample microfluidic valve in a closed configuration;

FIG. 2 shows valve performance under working conditions;

FIG. 3 shows valve performance under high pressures;

FIG. 4 shows images of sample microfluidic valve and device; and

FIG. 5 shows a computer system that is programmed or otherwise configured to implement methods of the present disclosure, such as directing a fluid flow in a microfluidic device.

FIG. 6A schematically illustrates a sample microfluidic valve in a closed configuration without the application of a pressure differential;

FIG. 6B schematically illustrates a sample microfluidic valve in an open configuration with the application of a pressure differential;

FIG. 7 schematically illustrates a sample microfluidic valve with a membrane comprising two polymeric layers in an open configuration;

FIG. 8 shows valve performance of a sample microfluidic valve, such as the sample microfluidic valve illustrated in FIG. 7 under various pressures.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

In an aspect, the present disclosure provides a microfluidic device. The microfluidic device may comprise at least one fluidic channel. In some cases, the microfluidic device comprises a plurality of fluidic channels (e.g., greater than or equal to about 2, 3, 4, 5, 6, 7, 8, 9, 10, 12, 14, 16, 18, 20, 25, 30, 35, 40, 45, 50, 55, 60, 65, 70, 75, 80, 85, 90, 100, 150, 200, 250, 300, 350, 400, 450, 500, 600, 700, 800, 900, 1,000 or more). Each fluidic channel may have at least one cross sectional dimension or size that is less than or equal to about 500 microns (μm), 400 μm, 300 μm, 200 μm, 100 μm, 50 μm, 40 μm, 30 μm, 20 μm, 10 μm, 5 μm, 1 μm, 500 nanometers or less. The microfluidic device may further comprise chambers and valves, alone or in combination with other microfluidic components (such as fluidic inlets, outlets). The microfluidic device can comprise a plurality of valves (e.g., greater than or equal to about 2, 3, 4, 5, 6, 7, 8, 9, 10, 12, 14, 16, 18, 20, 25, 30, 35, 40, 45, 50, 55, 60, 65, 70, 75, 80, 85, 90, 100, 150, 200, 250, 300, 350, 400, 450, 500, 600, 700, 800, 900, 1,000 or more). The microfluidic devices can be interconnected to form a microfluidic system comprising at least 2, 3, 4, 5, 6, 7, 8, 9, 10, 12, 14, 16, 18, 20, 25, 30, 35, 40, 45, 50, 55, 60, 65, 70, 75, 80, 85, 90, 100, 150, 200, 250, 300, 350, 400, 450, 500, 600, 700, 800, 900, 1,000 or more microfluidic devices.

In some cases, the microfluidic device comprises at least one valve. The microfluidic device including the valve may comprise multiple layers (e.g., greater than or equal to about 2, 3, 4, or 5 layers). Each of the layers may comprise multiple sub-layers. As provided herein, the microfluidic device comprising a valve(s) may comprise a fluidic layer, an actuation layer and a membrane sandwiched between the fluidic layer and the actuation layer. The actuation layer may be a pneumatic layer which is configured to supply a positive or a negative pressure. The positive or negative pressure may be supplied to the membrane to deflect at least a portion of the membrane. The membrane may comprise a thin film. The membrane may be deflected away or towards the fluidic layer. Such deflection may cause a fluid flow in a fluidic channel. Such deflection may subject a fluid to movement to or from the fluidic channel.

The fluidic layer of the valve may not comprise perpendicular sides. The fluidic layer of the valve may comprise at least one cross sectional area that has no perpendicular sides (i.e., no right angles) (90°). In some cases, the fluidic layer comprises at least one cross sectional area that has a non-rectangular shape. In some cases, the at least one cross sectional area of the fluidic layer has a curved shape. The curved shape may be a regular or an irregular shape. The curved shape may be symmetrical or asymmetrical. The curved shape may comprise a semi-circular shape, a semi-elliptical shape, a parabolic shape or a hyperbolic shape. The microfluidic device and components/parts thereof (such as valves, pumps) may be fabricated using 3D printing, laser ablation, polymer casting, milling, molding, thermoforming, silicon patterning, pressing or other fabrication technology.

The surface of a fluidic layer or an actuation layer that faces the membrane in a sandwich format is referred to as a mating face. A mating face may comprise functional elements such as conduits, valves and/or chambers that are exposed to and covered by the membrane. When mated together and assembled into a sandwich, portions of the mating faces that touch the membrane are referred to as sealing surfaces. Sealing surfaces may be bonded to or pressed against the membrane to seal the device against leaks.

Mating faces of the fluidic layer and/or the actuation layer can be substantially planar, flat or smooth. Fluidic channels and/or actuation channels (or conduits) may be formed in the surface of the fluidic or actuation layers as furrows, dimples, cups, open channels, grooves, trenches, indentations, impressions and the like. Conduits or passages can take any shape appropriate to their function. This includes, for example, channels having semi-circular, circular, rectangular, oblong or polygonal cross sections. Valves, reservoirs and chambers can be made having dimensions that are larger than channels to which they are connected. Chambers can have walls assuming circular or other shapes. Areas in which a conduit becomes deeper or shallower than a connecting passage can be included to change speed of fluid flow. A channel may have side walls that are parallel to each other or a top and bottom that are parallel to each other. A channel may comprise regions with different cross sectional areas or shapes. The channels may have the same or different widths and depths.

The fluidic layer, the actuation layer and the membrane may comprise or be made from the same materials. In some cases, the fluidic layer, the actuation layer and the membrane comprise or are made from the same materials. The membrane may comprise elastic materials, which materials may deform upon application of a pressure (e.g., a positive or a negative pressure) and return to its un-deformed state once the pressure is removed. The negative pressure may be vacuum. The positive or negative pressure may be from a single pressure source. The valves may be open or closed upon application of a pressure. In some cases, the valves remain open in the absence of an application of a pressure. In some cases, the valves are switched to a closed configuration when a pressure is exerted on the membrane.

Upon exertion of a pressure, the deformation dimension of the membrane may be less than or equal to about 10 millimeters (mm), 8 mm, 6 mm, 4 mm, 2 mm, 1 mm, 900 μm, 800 μm, 700 μm, 600 μm, 500 μm, 400 μm, 300 μm, 200 μm, 100 μm, or less. The materials may be flexible enough to form valves that are pneumatically actuatable. The materials may have a Young's modulus that is less than or equal to about 500 megapascals (MPa), 450 MPa, 400 MPa, 350 MPa, 300 MPa, 250 MPa, 200 MPa, 150 MPa, 100 MPa, 50 MPa, 1 MPa, 900 kilopascal (kPa), 800 kPa, 700 kPa, 600 kPa, 500 kPa or less. In some cases, the materials have a Young's modulus greater than or equal to about 200 kPa, 300 kPa, 400 kPa, 500 kPa, 600 kPa, 700 kPa, 800 kPa, 900 kPa, 1 MPa, 100 MPa, 200 MPa, 300 MPa, 400 MPa, or more. In some cases, the materials have a Young's modulus falling between any of the two values described herein, such as 345 MPa.

A variety of materials, including polymers, copolymers, resins, silicon, stainless steels etc., can be utilized in making the fluidic layer, the actuation layer and/or the membrane. Non-limiting examples of materials that can be used to manufacture one or more of the fluidic layer, the actuation layer and the membrane may comprise perfluoro elastomers (e.g., polytetrafluoroethylene, polyvinylidene fluoride), fluorinated ethylene propylene (FEP), perfluoroalkoxy alkane (PFA), polyethylenetetrafluoroethylene (ETFE), polyethylenechlorotrifluoroethylene (ECTFE), polychlorotrifluoroethylene (PCTFE), copolymers of hexafluoropropylene and tetrafluoroethylene, poly(methyl methacrylate) (PMMA), polydimethylsiloxane (PDMS), cyclic olefin copolymer (COC), polystyrene (PS), or combinations thereof. In some cases, all of the fluidic layer, the actuation layer and the membrane are made from FEP, PFA or combinations thereof. In some cases, the microfluidic device is essentially made of FEP, PFA or combinations thereof, and various parts/components of the device are heat bonded. In some cases, the microfluidic device and components/parts thereof (such as valves, pumps) are formed monolithically. The fluidic layer, the membrane, and the actuation layer may be formed of the same polymeric materials. The fluidic layer and the actuation layer can be formed of different materials. The fluidic layer, the membrane, and the actuation layer can be formed of different polymeric materials.

The membrane can comprise of more than one polymeric material. The polymeric layers of the membrane may be formed of the same polymeric material. The polymeric layers of the membrane can be formed of different polymeric materials. One polymeric layer of the membrane can comprise the same material as the fluidic layer and another polymeric (or polymer) layer of the membrane can comprise the same material as the actuation layer. Alternatively, one polymeric layer of the membrane can be formed of a different material than the fluidic layer and another polymeric layer of the membrane can be formed of a different material than the actuation layer.

In some cases, the actuation layer comprises actuation conduits or channels. The membrane may cover the actuation conduits comprised in the actuation layer. The fluidic layer may comprise one or more fluidic channels and valves may be configured in the fluidic layer as interruptions in the fluidic channels. The fluidic channels of the valve may not comprise perpendicular sides. The fluidic channel of the valve may comprise at least one cross sectional area that has no perpendicular sides (i.e., no right angles) (90°). In some cases, the fluidic channel comprises at least one cross sectional area that has a non-rectangular shape. In some cases, at least one cross sectional area of the fluidic channel has a curved shape. The curved shape may be a regular or an irregular shape. The curved shape may be symmetrical or asymmetrical. The curved shape may comprise a semi-circular shape, a semi-elliptical shape, a parabolic shape or a hyperbolic shape. The fluidic channels may have a curved cross-sectional shape such that when a pressure is exerted, deflection of the membrane towards the channels can displace any volume that may be contained in the channels (i.e., zero dead volume). The microfluidic device may comprise a plurality of valves and some or all of which are zero dead volume valves.

Valves of the present disclosure can displace defined volumes of fluid. A valve can displace a defined volume of liquid when the valve is moved to a closed or an open configuration. For example, a fluid contained in a fluidic channel when the valve is open may be moved out of the channel when the valve is closed. The valve may displace fluid volumes (e.g., upon each closing of the valve) that are less than or equal to about 20 microliters (μL), 18 μL, 16 μL, 14 μL, 12 μL, 10 μL, 8 μL, 6 μL, 4 μL, 2 μL, 1 μL, 0.9 μL, 0.8 μL, 0.7 μL, 0.6 μL, 0.5 μL, 0.4 μL, 0.3 μL, 0.2 μL per centimeter (cm) of the channel, or less. The valve may displace fluid volumes that are greater than or equal to about 0.01 μL, 0.05 μL, 0.1 μL, 0.3 μL, 0.5 μL, 0.7 μL, 0.9 μL, 1 μL, 3 μL, 5 μL, 7 μL, 9 μL, 11 μL, 13 μL, 15 μL, 17 μL, 19 μL, 21 μL per cm of the channel, or more. In some cases, the valve displaces fluid volume falling between any of the two values described herein, e.g., between about 0.2 μL and about 5 μL per cm of the channel.

As described above or elsewhere herein, the actuation layer may be a pneumatic layer. The pneumatic layer may comprise one or more pneumatic channels. In some cases, the pneumatic layer comprises a plurality of pneumatic channels. A pressure may be exerted or applied to the membrane via the pneumatic channels. Upon exertion of a pressure, the valves may be switched to an open or a closed configuration. In cases where the microfluidic device comprises a plurality of valves, each valve may be independently actuated by a different pneumatic channel. Alternatively or additionally, each pneumatic channel is used to actuate a couple of valves (e.g., about 2, 3, 4, 5, 6, 7, 8, 9, 10 valves, or more). In some case, multiple valves may be actuated in a pre-defined sequence to regulate a fluid flow in a given fluidic channel.

The pneumatic channels may have a width greater than a width of the fluidic channels comprised in the fluidic layer. In some cases, the pneumatic channels have a width greater than a width of the fluidic layer.

The width of the pneumatic channels can be greater than or equal to about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, or more. In some cases, the width of pneumatic channels is less than or equal to about 1,000 μm, 900 μm, 800 μm, 700 μm, 600 μm, 500 μm, 400 μm, 300 μm, 200 μm, 100 μm, 75 μm, 50 μm, 25 μm, 10 μm, or less. The depth of the pneumatic channels may be greater than or equal to about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, or more. In certain cases, the depth of the pneumatic channels is less than or equal to about 1,000 μm, 900 μm, 800 μm, 700 μm, 600 μm, 500 μm, 400 μm, 300 μm, 200 μm, 100 μm, 75 μm, 50 μm, 25 μm, 10 μm, or less.

The fluidic channels may have a depth that is greater than or equal to about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, or more. In some cases, the fluidic channels have a depth less than or equal to about 1,000 μm, 900 μm, 800 μm, 700 μm, 600 μm, 500 μm, 400 μm, 300 μm, 200 μm, 100 μm, 75 μm, 50 μm, 25 μm, 10 μm, or less. In some cases, the fluidic channels have a depth falling from and to any of the two values described herein, for example, from about 1 μm to about 1,000 μm, or from about 10 μm to about 300 μm.

The fluidic channels may have a width that is greater than the depth. In some cases, the fluidic channels may have a width that is at least about 2 times, 3 times, 4 times, 5 times, 6 times, 7 times, 8 times, 9 times, 10 times, 12 times, 14 times, 16 times, 18 times, 20 times, 22 times, 24 times, 26 times, 28 times, 30 times, 32 times, 34 times, 36 times, 38 times, 40 times, 45 times, 50 times the depth, or more. In some cases, the width of the channels is about 5-50 times of the depth. In certain cases, the width of the channels is about 10-20 times the depth. A lower value of width/depth ratio may enable easier or improved bonding of the layers (i.e., the pneumatic layer, the fluidic layer and/or the membrane). A higher width/depth ratio may allow for a lower pressure to switch between a closed state (or configuration) and an open state (or configuration) of the valve. The depth and the width of the channels may be optimized to allow easy closure of the valve with exertion of low pressure while allowing relatively easy bonding of the layers.

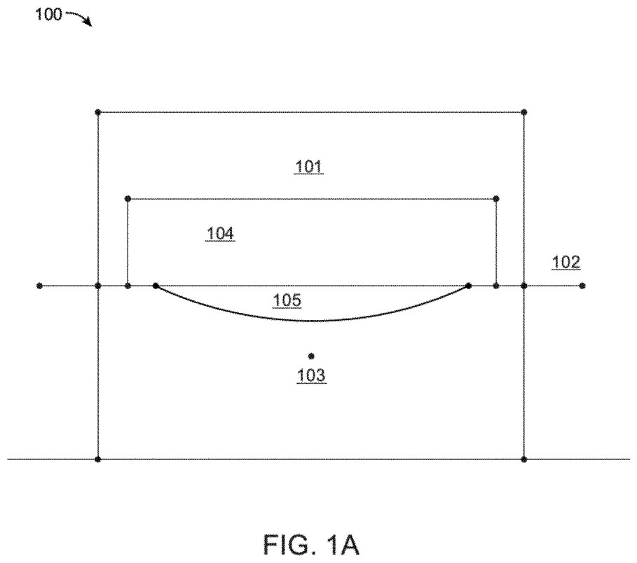

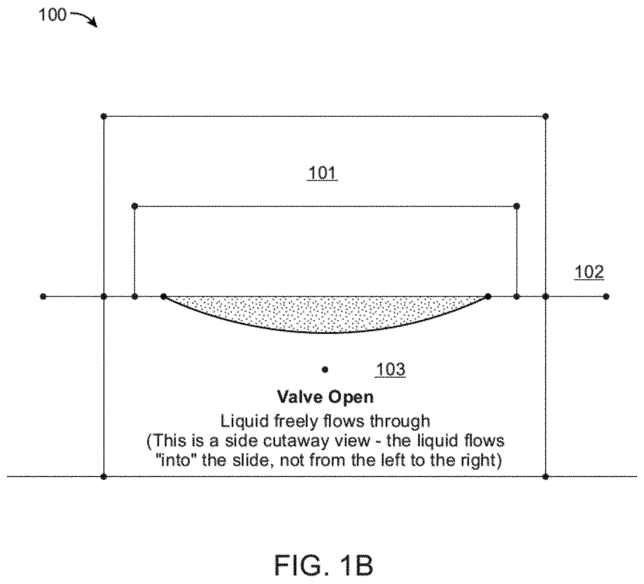

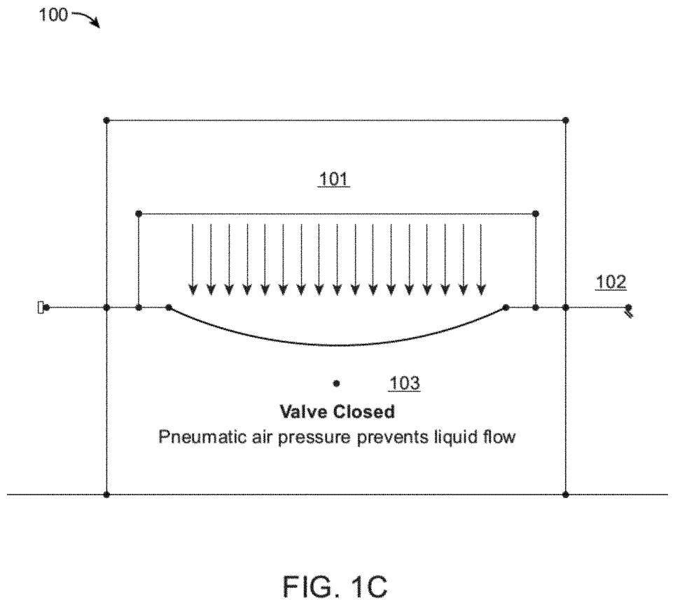

Thickness of the membrane may vary. In some cases, it is desirable to have a membrane which is relatively thin, e.g., a thin film. The thickness of the membrane may be less than or equal to about 50 μm, 45 μm, 40 μm, 35 μm, 30 μm, 25 μm, 20 μm, 18 μm, 16 μm, 14 μm, 12 μm, 10 μm, 8 μm, 6 μm, 4 μm, or less. In some cases, the membrane has thickness falling between any of the two values described herein, e.g., from about 12 μm to about 25 μm. FIG. 1A shows a sample microfluidic valve 100 comprised in a microfluidic device of the present disclosure. As shown in the figure, the valve may comprise a pneumatic layer 101, a membrane 102 and a fluidic layer 103. The membrane may be sandwiched between the pneumatic layer and the fluidic layer. The pneumatic layer may comprise a pneumatic channel (or conduit) 104 and the fluidic layer may comprise a fluidic channel 105.

The pneumatic channel may have a width that is greater than a width of the fluidic channel. Surface area of a surface of the pneumatic channel facing the fluidic layer may be greater than that of the fluidic channel such that fluidic channel may be fully covered by the pneumatic channel. The pneumatic channel may have a cross-sectional area that is of a rectangular shape. The fluidic channel may have a curved cross-sectional shape. When a pressure is exerted on the membrane via the pneumatic channel, the membrane may be deformed and deflected towards or away from the fluidic channel, thereby switching between a closed configuration and an open configuration. In cases where the membrane deflects towards the fluidic channel, given the curved shape of the channel, the membrane may cover the entire surface area of an inner surface of the fluidic channel and displace all or substantially all fluid volume that may be contained in the channel. In some examples, the membrane may restrict the flow of fluid in the channel and displace at least 1%, 5%, 10%, 20%, 30%, 40%, 50%, 60%, 70%, 80%, 90%, 95%, 99%, 99.9%, or more of the fluid volume contained in the channel. In some cases, the membrane may displace about 1%, 5%, 10%, 20%, 30%, 40%, 50%, 60%, 70%, 80%, 90%, 95%, 99%, 99.9% or more of the fluidic volume contained in the channel. In some examples, the pneumatic channel has a width that is greater than a width of the liquid channel comprised in the liquid layer. As to the liquid channel, it may have a depth that is greater than 10 μm. In some cases, the liquid channel has a depth between 10 μm and 300 μm. The liquid channel may have a depth greater than 300 μm, 400 μm, 500 μm, 600 μm, 700 μm, 800 μm, 900 μm, or 1000 μm. The width of the fluidic channel may be about 10-20 times the width of the channel. A lower value of width/depth ratio may enable easier bonding of the layers (i.e., the pneumatic layer, the fluidic layer and/or the membrane). A higher width/depth ratio may allow for a lower pressure to switch between a closed and an open configuration of the valve. For the membrane, it may be a film which may be deformable upon exertion of pressures. It may be desirable to have a film as thin as possible. For example, the film may have a thickness that is between about 50 μm and about 300 μm.

FIG. 1B illustrates a cross-sectional view of a sample microfluidic valve at an open configuration. In this example, the valve remains open without having a pressure exerted on the membrane and a fluid may flow freely through the fluidic channel. It will be appreciated that in some cases, the valve remains closed when a pressure is not exerted on the membrane and a fluid may not flow through the fluidic channel.

FIG. 1C shows a cross-sectional view of a sample microfluidic valve at a closed configuration. As illustrated in the figure, when a pressure is exerted on the membrane, the membrane may deflect away from the pneumatic layer and towards the fluidic layer. The deflection or deformation of the membrane may displace all fluid volume which may be contained in the fluidic channel. Upon exertion of the pressure, the membrane may be made in full contact with an inner surface of the fluidic channel given the curved shape of the channel such that any fluid volume that may be trapped or contained in the fluidic channel may be displaced. Thus, closing the valve may excavate 100% of the valve displacement area, making the valve a zero dead volume valve. Such zero dead volume valves may eliminate cross-contaminations of reagents/samples or other types of fluid among different runs, thus allowing for a microfluidic device comprising the valves being reusable. As discussed above or elsewhere herein, the pressure may be a positive pressure or a negative pressure such as vacuum.

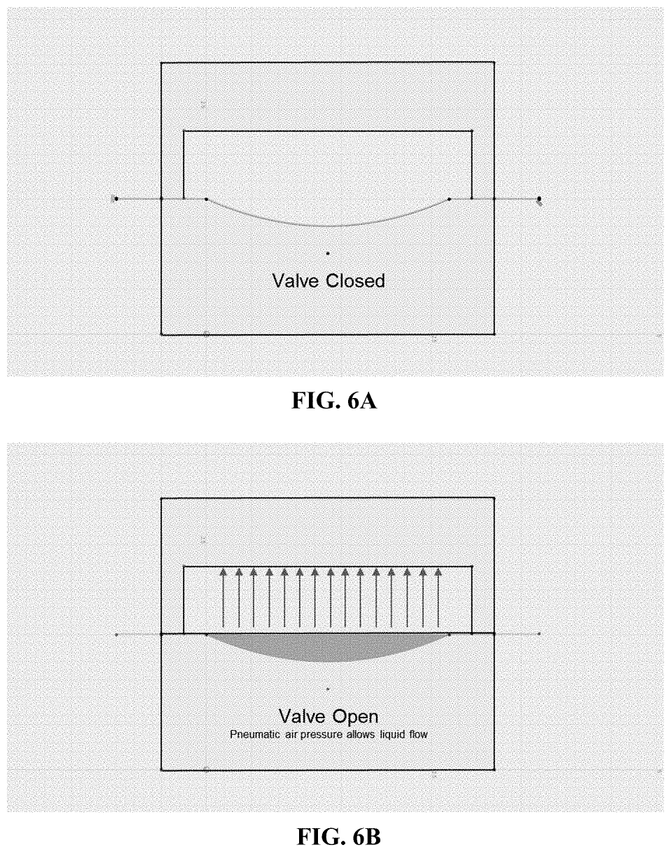

In some cases, exertion of a pressure on the membrane may cause a valve to switch from a closed configuration to an open configuration which makes a fluidic able to flow freely through a fluidic channel. The pressure can be a negative pressure (e.g., a vacuum). FIG. 6A shows a cross-sectional view of a sample microfluidic valve at a closed configuration. The valve may remain closed when a pressure is not exerted on the membrane and a fluid may not flow through the fluidic channel. As illustrated, when no pressure is exerted on the membrane, the membrane may remain in full contact with the inner surface of the fluidic channel. The closed valve may keep the valve displacement area 100% empty of fluid, making the valve a zero dead volume valve. The zero dead volume valves may eliminate cross-contaminations of reagents/samples or other types of fluid among different runs, thus allowing the microfluidic device comprising the valve to be reusable.

The exertion of a negative pressure on the membrane may cause the valve to switch from a closed configuration to an open configuration as in FIG. 6B. When a negative pressure is exerted on the membrane via the pneumatic channel, the membrane can be deformed and deflected away from the fluidic channel, and thereby switching to an open configuration. This allows the flow of liquid in the fluidic channel. In some aspects, the present disclosure provides methods for directing a fluidic flow in a microfluidic device. The methods may comprise providing a microfluidic device as discussed above or elsewhere herein. For example, the microfluidic device may comprise one or more microfluidic valves. The microfluidic device comprising the valve may have a three-layer structure, i.e., an actuation layer, a fluidic layer and a membrane sandwiched between the actuation layer and the fluidic layer. The actuation layer may be a pneumatic layer which is configured to exert a pressure onto the membrane. The microfluidic device may comprise one or more fluidic channels, at least some of which may be in communication with the valves. In some cases, the fluidic channels are comprised in the fluidic layer. The fluidic layer in the valve may not comprise perpendicular sides or any sides having right (90°) angles. In some cases, at least some of the fluidic channels of the valve do not have perpendicular sides or a side comprising right angels. In some cases, at least some of the fluidic channels of the valve have a cross-sectional shape which has no perpendicular sides or a side having right angles. The cross-sectional shape may not be a square or rectangular shape. The cross-sectional shape may be a regular or irregular shape. The cross-sectional area may have a curve shape such that when the membrane deflects upon exertion of a pressure, the membrane may be made in full contact with an inner surface of a given fluidic channel, thereby displacing any fluidic volume that may be contained in the channel. In some cases, the deflection of the membrane causes a microfluidic valve to be switched to a closed configuration. The closing of the valves may displace or expel at least about 90%, 91%, 92%, 93%, 94%, 95%, 96%, 97%, 98%, 99%, 99.5% (vol %) fluid which may be contained in the fluidic channel, or more. The valves of the present disclosure may be zero dead volume valves. The valves may minimize or eliminate cross-contamination of samples/reagents/fluids among different runs, thus making the microfluidic device reusable.

The methods may further comprise applying a positive or a negative pressure to the membrane. The pressure may be applied via the actuation layer (e.g., a pneumatic layer). Upon application of the pressure, the membrane may deflect towards or away from the fluidic layer, thereby preventing or enabling a fluid flow through the fluidic layer (i.e., subjecting a fluid to movement to or from fluidic channels in the fluidic layer).

Some aspects of the present disclosure provide a microfluidic device comprising a fluidic channel and a valve. The valve may be in fluidic communication with the fluidic channel. The valve may comprise an actuation layer (e.g., a pneumatic layer). The actuation layer may be configured to supply a positive or negative pressure. The valve may further comprise a fluidic layer. The fluidic layer may be coupled to a support. The fluidic layer may comprise a surface. The surface may be oriented at an angle of less than 90° relative to a plane parallel to the support. The valve may further comprise a membrane. The membrane may be sandwiched between the actuation layer and the fluidic layer. The membrane may be configured to actuate upon application of the positive or negative pressure from the actuation layer. Upon actuation, the membrane may be deflected towards or away from the fluidic layer, thereby subjecting a fluidic to movement to or from a fluidic channel comprised in the fluidic layer.

In some cases, the microfluidic device can comprise a membrane that comprises more than one polymeric layer. The membrane can include at least 2, 3, 4, 5, 6, 7, 8, 9, 10, or more polymeric layers. The polymeric layers may be formed of different materials. The polymeric layers may be formed of the same material. Subsets of the polymeric layers (e.g., layers 1 and 2) may be formed of the same material, and the material of such subsets may be different from other layers (e.g., layers 3 and 4).

The microfluidic device can comprise a valve comprising an actuation layer, a fluidic layer in fluid communication with a fluidic channel, and a membrane between said actuation layer and said fluidic layer, wherein said membrane comprises at least two polymeric layers, wherein said actuation layer is configured to actuate said membrane to cause said membrane to move towards or away from a surface of said fluidic layer, wherein when said membrane is disposed away from said surface, said valve is configured to permit fluid flow through said fluidic channel, and when said membrane is in contact with said surface, said valve is configured to impede fluid flow in said fluidic channel. In some cases, the membrane may comprise two polymeric layers. The membrane may comprise three, four, or five polymeric layers. One polymeric layer can be adjacent to the fluidic layer and the fluidic channel, while another polymeric layer can be adjacent to the actuation layer and the pneumatic channel. The multiple layers can prevent the exposure of the layer adjacent to pneumatic channel from contacting the fluid in the fluidic channel. This can reduce contamination and increase the reusability of the microfluidic device.

In certain cases, the membrane, the fluidic layer, and/or actuation layer can be formed of polymeric materials. Non-limiting examples of polymeric materials are perfluoro elastomers such as polytetrafluoroethylene (PTFE), polyvinylidene fluoride (PVDF), fluorinated ethylene propylene (FEP), perfluoroalkoxy alkane (PFA), polyethylenetetrafluoroethylene (ETFE), polyethylenechlorotrifluoroethylene (ECTFE), polychlorotrifluoroethylene (PCTFE), copolymers of hexafluoropropylene and tetrafluoroethylene, poly(methyl methacrylate) (PMMA), silicones such as polydimethylsiloxane (PDMS), cyclic olefin copolymer (COC), polystyrene (PS), and any combination thereof. In some cases, all of the fluidic layer, the actuation layer and the membrane are formed of the same polymeric material. In other cases, the fluidic layer and the actuation layer are formed of different polymeric materials. In certain cases, the fluidic layer, the actuation layer, and the membrane are formed of different polymeric materials. The fluidic layer can comprise polymeric material with low or no reactivity. The polymeric material of the fluidic layer may have anti-contamination properties. The polymeric material of the fluidic layer can be perfluoro elastomers. In certain cases, the polymeric material of the fluidic layer can be FEP. The polymeric material of the actuation layer may be PDMS. In certain cases, the actuation layer may be formed of PDMS and the fluidic layer may be formed of FEP.

The polymeric layers of the membrane may be formed of the same polymeric material. In certain cases, the polymeric layers of the membrane can be formed of different polymeric materials. In some cases, one of the polymeric layers of the membrane can comprise the same material as the fluidic layer and another polymer layer can comprise the same material as the actuation layer. In some cases, the polymeric material of the actuation layer may be deflected or deformed upon exertion of a pressure and therefore may be driven pneumatically. The polymeric layer adjacent to the actuation layer may comprise PDMS. The polymeric layer adjacent to the fluidic layer may comprise polymeric material with low or no reactivity. The polymeric layer adjacent to the fluidic layer can be FEP. In some cases, the polymeric layer adjacent to the actuation layer may be formed of PDMS and the polymeric layer adjacent to the fluidic layer may be formed of FEP.

The actuation layer may be a pneumatic layer. The actuation layer may be configured to apply a positive or negative pressure to the membrane. In certain cases, the microfluidic device can comprise a chip comprising the valve and fluidic layer. The fluidic layer may comprise fluidic channels. The fluidic layer and/or fluidic channels may comprise a surface that is oriented at an angle of less than 90° relative to a plane parallel to the support. In some cases, the fluidic layer of the valve does not have perpendicular sides. The membrane may be configured to actuate upon application of the positive or negative pressure from the actuation layer. Upon actuation, the membrane may be deflected towards or away from the fluidic layer, thereby subjecting a fluidic to movement to or from a fluidic channel comprised in the fluidic layer.

The fluidic channels the microfluidic device may have a depth that is greater than or equal to about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, or more. In some cases, the fluidic channels have a depth less than or equal to about 1,000 μm, 900 μm, 800 μm, 700 μm, 600 μm, 500 μm, 400 μm, 300 μm, 200 μm, 100 μm, 75 μm, 50 μm, 25 μm, 10 μm, or less. In some cases, the fluidic channels have a depth from and to any of the two values described herein, for example, from about 1 μm to about 1,000 μm, or from about 10 μm to about 300 μm.

The fluidic channels may have a width that is greater than the depth. In some cases, the fluidic channels may have a width that is at least about 2 times, 3 times, 4 times, 5 times, 6 times, 7 times, 8 times, 9 times, 10 times, 12 times, 14 times, 16 times, 18 times, 20 times, 22 times, 24 times, 26 times, 28 times, 30 times, 32 times, 34 times, 36 times, 38 times, 40 times, 45 times, 50 times the depth, or more. In some cases, the width of the channels is about 5-50 times of the depth. In certain cases, the width of the channels is about 10-20 times the depth. A lower value of width/depth ratio may enable easier bonding of the layers (i.e., the pneumatic layer, the fluidic layer and/or the membrane). A higher width/depth ratio may allow for a lower pressure to switch between a closed and an open configuration of the valve. The depth and the width of the channels may be optimized to allow easy closure of the valve with exertion of low pressure while allowing relatively easy bonding of the layers.

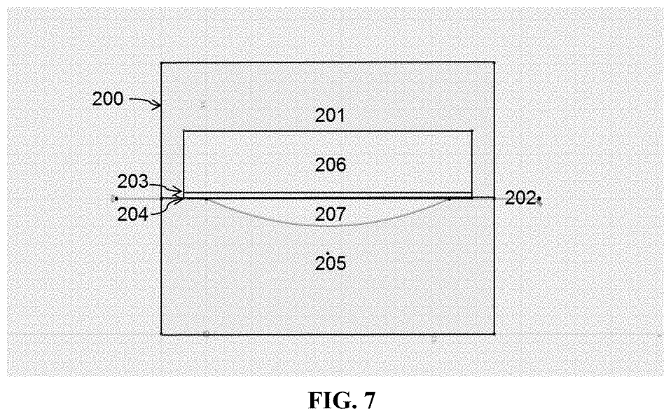

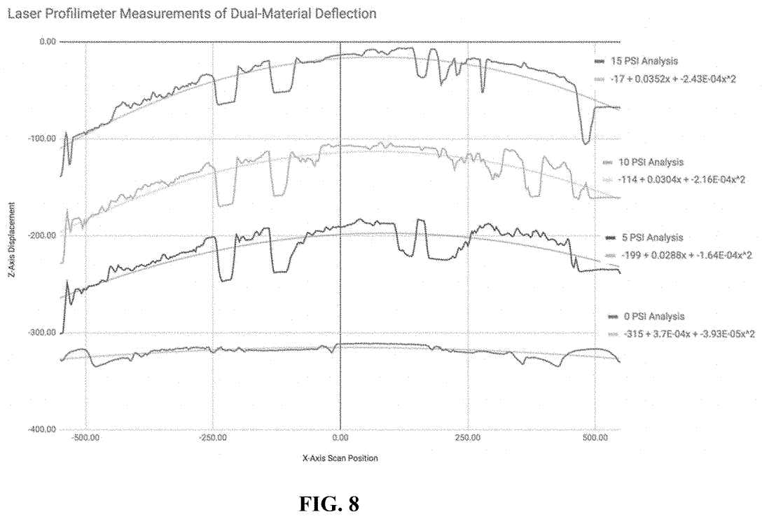

FIG. 7 shows a sample valve 200 of a microfluidic device in an open configuration. The valve may comprise an actuation layer 201, a membrane 202, and a fluidic layer 205 with the membrane 202 positioned between the actuation layer 201 and said fluidic layer 205. The membrane 202 may comprise a first polymeric layer 203 and a second polymeric layer 204. The first polymeric layer 203 is adjacent to actuation layer 201 and the pneumatic channel 206, while the second polymeric layer is adjacent to the fluidic layer 205 and the fluidic channel 207.

Some aspects of the present disclosure provide methods for regulating a fluidic flow. The methods may comprise providing a microfluidic device as provided herein. For example, the microfluidic device may comprise one or more fluidic channels. The microfluidic device may comprise one or more valves. The valves may be microfluidic valves. The microfluidic device comprising the valves may have at least three layers—i.e., an actuation layer, a fluidic layer and a membrane between the actuation layer and the fluidic layer. The fluidic layer may comprise the microfluidic channels. The valves may also comprise the three-layer structures. The valves may be in fluidic communication with one or more fluidic channels.

The actuation layer may be a pneumatic layer. The actuation layer may be configured to apply a positive or negative pressure to the membrane. The fluidic layer may be coupled to a support. The fluidic layer may comprise fluidic channels. The fluidic layer and/or fluidic channels may comprise a surface that is oriented at an angle of less than 90° relative to a plane parallel to the support. The membrane may be configured to actuate upon application of the positive or negative pressure from the actuation layer. Upon actuation, the membrane may be deflected towards or away from the fluidic layer, thereby subjecting a fluidic to movement to or from a fluidic channel comprised in the fluidic layer.

In some cases, the methods further comprise applying the positive or negative pressure to the membrane. The membrane may be deflected towards or away from the fluidic layer upon application of the pressure. The deflection of the membrane may cause a valve to open or close, thereby allowing or preventing a fluid flow through the fluidic layer.

Also provided in the present disclosure is a microfluidic device comprising at least one zero dead volume valves. The microfluidic device may comprise one or more fluidic channels and/or microfluidic valves. The valves may be in fluidic communication with the fluidic channels. The microfluidic device comprising the valves may comprise at least three layers—an actuation layer, a fluidic layer and a membrane between the actuation layer and the fluidic layer. The fluidic layer may comprise the fluidic channels. The microfluidic valves may be interruptions of the fluidic channels. In some cases, the valves each comprises an actuation layer (such as a pneumatic layer) configured to exert a pressure (a positive or a negative pressure) to the membrane. The negative pressure may be vacuum. Upon exertion of the pressure, the membrane may deflect away or towards the fluidic layer, causing the valves actuable between an open configuration and a closed configuration. In some cases, when a valve changes from an open configuration to a closed configuration, the membrane moves from a first position to a second position relative to the fluidic layer. Such movement of the membrane may be along a direction perpendicular to a plane of the fluidic layer of the valve and expel any fluid that may be contained in a fluidic channel comprised in the fluidic layer, thereby regulating a fluid flow in the fluidic channel.

The actuation layer may be a pneumatic layer. The pneumatic layer may comprise one or more pneumatic channels. In some cases, the pneumatic layer comprises a plurality of pneumatic channels and each valve may be actuated by a different pneumatic channel. In some cases, the microfluidic device comprises a plurality of valves which may be actuated in a pre-defined sequence to thereby regulate a fluidic flow through the microfluidic device. In some cases, the microfluidic device comprises a plurality of fluidic channels and fluid in each channel is regulated by a given subset of the valves comprised in the microfluidic device. In some cases, the microfluidic device is configured to perform multiple processes or reactions in parallel, and given subsets of fluidic channels and valves are configured to perform each of the multiple processes or reactions simultaneously and independently.

Methods for regulating a fluidic flow using microfluidic valves of the present disclosure in a microfluidic device are also provided. The methods may comprise providing a microfluidic device comprising one or more fluidic channels and/or microfluidic valves. The valves may be in fluidic communication with the fluidic channels. The valves may comprise a pneumatic layer, a fluidic layer and a membrane sandwiched between the fluidic layer and the pneumatic layer. A positive or negative pressure may be exerted on the membrane via the pneumatic layer. The pneumatic layer may comprise a plurality of pneumatic channels, each of which is configured to actuate one or more of the valves. In some cases, each of the pneumatic channels is configured to independently actuate a given valve. In some cases, each of the pneumatic channels is configured to control multiple valves. In some cases, a subset of the pneumatic channels is configured to actuate one or more valves to thereby regulate a fluid flow in fluidic channels. Upon exertion of the pressure on the membrane, the membrane may be deflected away from or towards fluidic layer and the valve may be actuable between an open configuration and a closed configuration.

In some cases, the methods further comprise applying the positive or negative pressure to the membrane via the pneumatic layer to actuate the valve. Upon actuation, the membrane may move from a first position to a second position relative to the fluidic layer, causing the valve to switch between an open configuration and a closed configuration. The movement of the membrane from the first position to the second position may be along a direction that is perpendicular to a plane of the fluidic layer. The closing of the valve may expel any fluid which may be contained in a given fluidic channel comprised in the fluidic layer, thereby regulating a fluid flow in the fluidic channel.

In another aspect, the present disclosure provides a method of operating a microfluidic device comprising: providing the microfluidic device disclosed herein; and actuating said membrane to cause said membrane to move towards or away from a surface of said fluidic layer, to permit fluid flow through said fluidic channel when said membrane is disposed away from said surface, or impede fluid flow in said fluidic channel when said membrane is in contact with said surface. The microfluidic device may comprise a valve comprising an actuation layer, a fluidic layer in fluid communication with a fluidic channel, and a membrane between said actuation layer and said fluidic layer. The actuation can be done by supplying a positive or negative pressure to the membrane. In some cases, the membrane can comprise more than one polymeric layer. In certain cases, the membrane can comprise two polymeric layers. In other cases, the membrane can comprise three, four, or five polymeric layers.

In one aspect, the present disclosure provides a method of constructing a microfluidic device disclosed herein, comprising providing at least two polymeric layers; and disposing said at least two polymeric layers between an actuation layer and a fluidic layer in fluid communication with a fluidic channel, to form a valve comprising a membrane having said at least two polymeric layers as part of said microfluidic device. In certain cases, the membrane can comprise two polymeric layers. In some cases, the membrane can comprise at least three, four, or five polymeric layers. In some cases, the polymeric layers can be attached to each other. The attached polymeric layers can be bonded to each other. The attached polymeric layers can be actuated in unison. In other cases, the polymeric layers are separated from one another. The actuation of one of the separated polymeric layers can cause deformation or deflection of the polymer layer adjacent to it.

In certain cases, a microfluidic device can be constructed by bonding the fluidic layer, the membrane, and the actuation layer together simultaneously. In other cases, one of the polymeric layers can be bonded to the fluidic layer and another polymeric layer can be bonded to the actuation layer, and then the polymeric layers may be attached to each other, bringing the fluidic layer and actuation layer together to form the microfluidic device. The multi-step bonding process can allow easier construction of the microfluidic device by putting less stress on the membrane compared to the one-step bonding during the construction process. Various methods including, but not limited to, ultrasonic welding, lamination, and induction heat-bonding can be utilized to perform the bonding.

The actuation layer and/or the fluidic layer can be formed by applying lithography techniques on polymeric materials. In some cases, the actuation layer and/or the fluidic layer can be formed by lamination, polymer casting, milling, ablation, molding, and/or 3D printing. Vertical molding can be employed to allow air bubbles to rise and reduce the defect formed by air bubbles. Non-limiting examples of polymeric materials are perfluoro elastomers such as polytetrafluoroethylene (PTFE), polyvinylidene fluoride (PVDF), fluorinated ethylene propylene (FEP), perfluoroalkoxy alkane (PFA), polyethylenetetrafluoroethylene (ETFE), polyethylenechlorotrifluoroethylene (ECTFE), polychlorotrifluoroethylene (PCTFE), copolymers of hexafluoropropylene and tetrafluoroethylene, poly(methyl methacrylate) (PMMA), silicones such as polydimethylsiloxane (PDMS), cyclic olefin copolymer (COC), polystyrene (PS), or any combination thereof. In some cases, all of the fluidic layer, the actuation layer and the membrane are formed of the same polymeric material. In other cases, the fluidic layer and the actuation layer are formed of different polymeric materials. In certain cases, the fluidic layer, the actuation layer, and the membrane are formed of different polymeric materials.

The microfluidic systems and devices disclosed herein can be utilized for a number of biochemical reactions, including nucleic acid synthesis and sequencing, and protein synthesis.

### Computer Systems

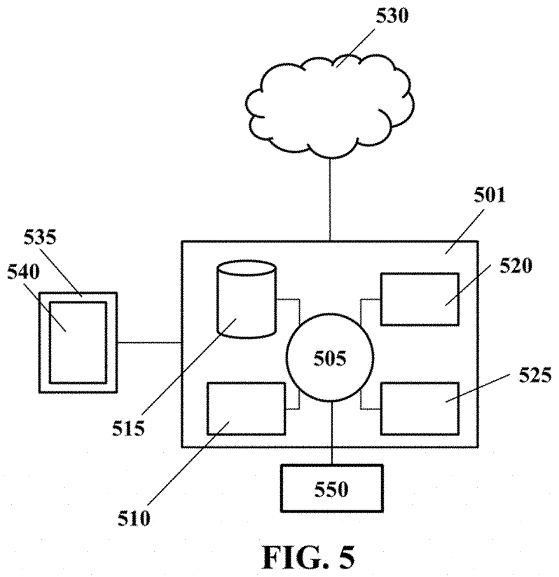

The present disclosure provides computer control systems that are programmed or otherwise configured to implement methods provided herein, such as directing a fluid flow in a microfluidic device, or mixing reagents for reactions using a microfluidic device. FIG. 5 shows a computer system 501 that includes a central processing unit (CPU, also “processor” and “computer processor” herein) 505, which can be a single core or multi core processor, or a plurality of processors for parallel processing. The computer system 501 can be an electronic device of a user or a computer system that is remotely located with respect to the electronic device. The electronic device can be a mobile electronic device. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. The circuit can be a microcontroller. In some cases, the circuit may be an application specific integrated circuit (ASIC). In some cases, the circuit may be a field-programmable gate array (FPGA).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet. The computer system 501 can communicate with one or more remote computer systems through the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

The computer system 501 can be programmed or otherwise configured to regulate one or more parameters, such as rates of fluid flow in a microfluidic device, temperatures, volumes, types of fluids/reagents in fluid channel(s) of a microfluidic device or other parameters.

Another aspect of the systems and methods provided herein may comprise one or more computer processors coupled with sensors. The sensors can provide data that, upon reading by the one or more computer processors, may change the execution path of the executable code that implements any of the methods above or elsewhere herein. The sensor data may include, but not be limited to, frequency and intensity of light, electrical resistivity, pressure of air and liquid, flow rate of air and liquid, magnetic field, and change in temperature.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, signals from a chip with time. Examples of UI's include, without limitation, a graphical user interface (GUI), web-based user interface, and mobile application.

Methods and systems of the present disclosure can be implemented by way of one or more algorithms. An algorithm can be implemented by way of software upon execution by the central processing unit 505.

The central processing unit 505 can be coupled to one or more sensors 505 configured to sense one or more parameters, such as rates of fluid flow in a microfluidic device, temperatures, volumes or types of fluids/reagents in fluid channel(s) of a microfluidic device. The gathered sensor data can be read by the central processing unit 505 and may trigger branching or a change of the code path that central processing unit 505 executes.

### Example

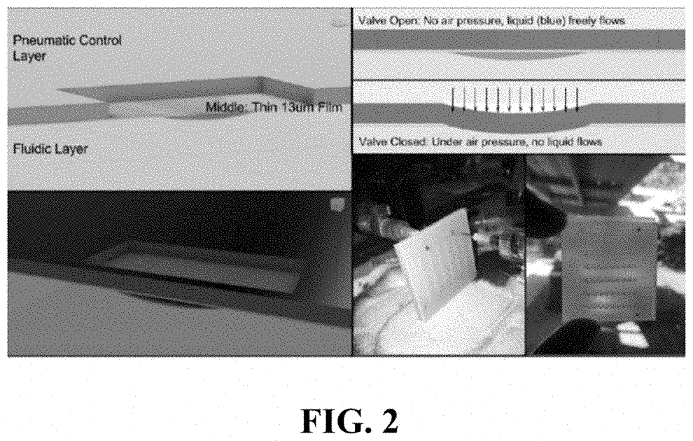

FIG. 2 shows a sample microfluidic device comprising of microfluidic valves. FIG. 2 (left top) shows a cut-away view of valve construction. As shown in the figure, the valve comprises a pneumatic later, a fluidic layer and a membrane between the pneumatic layer and the fluidic layer. The membrane is a thin film, which has a thickness of about 13 μm. A three-dimensional (3D) image of the microfluidic valve is shown in left bottom view of FIG. 2. FIG. 2 (right top) illustrates a sample valve changing from an open configuration to a closed configuration upon application of a pressure to the membrane of the valve. FIG. 2 (bottom right) shows a picture of a sample microfluidic device comprising the valves. The microfluidic device can be reused, e.g., used for multiple batches of different operations (such as chemical, biological, biochemical or medical processes or methods) without cross-contamination.

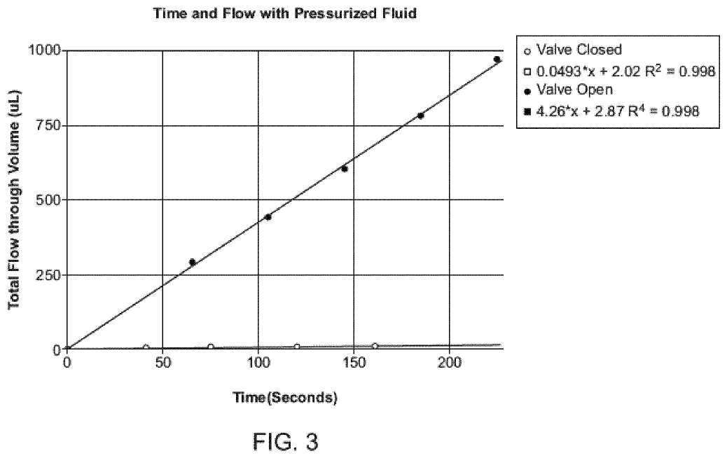

Test results of a sample valve in a microfluidic device are illustrated in FIG. 3. During operation, the valves are changed between an open configuration and a closed configuration. Each time when the valve is changed to a closed configuration, any fluid volume comprised in a fluidic channel may be expelled or displaced. Once the valve is changed to an open configuration, a fluid may flow freely through a fluidic channel in the microfluidic device. As shown in the figure, valves of the present disclosure permit fluid flow freely when the valves are open and exhibit negligible flow when the valves are closed.

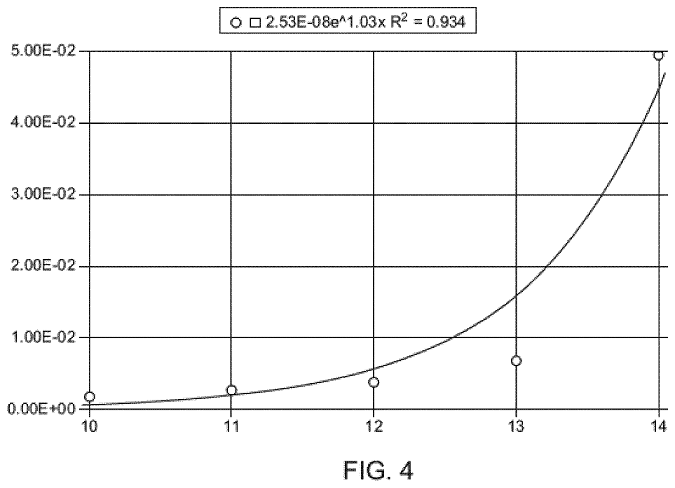

Operations of valves under extreme conditions are also tested and the results are shown in FIG. 4. The valves are operated under a pressure which is about 2-3 pound per square inch (PSI) away from a burst pressure of the materials used to manufacture the pneumatic layer, the membrane and/or the fluidic layer of the valves. As shown in the figure, the valves perform well even when being operated under such high pressures.

FIG. 8 shows deflection of a membrane when pressures of different levels (0, 5, 10, and 15 pounds per square inch) were applied to the membrane via the pneumatic channel. The X-Axis scan position denotes the position on the membrane along the horizontal axis in a cross-sectional view much like FIG. 7. The Z-axis displacement illustrates the position of the membrane along the vertical axis in the cross-sectional view. The membrane was comprised of two polymeric layers of different materials. Before the pressure was exerted, the membrane was in an open configuration as indicated by the curve associated with 0 pounds per square inch (PSI) analysis. With the pressure was increased, the membrane was deflected to be closer to the inner surface of the fluidic channel. Exertion of 15 PSI deformed the membrane to be near the curved inner surface of the fluidic channel, switching the valve to a closed configuration.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-72. (canceled)

73. A microfluidic device comprising:
a fluidic channel; and
a valve in fluidic communication with said fluidic channel, wherein said valve comprises (i) a pneumatic layer configured to supply a positive or negative pressure, (ii) a fluidic layer coupled to a support, wherein said fluidic layer comprises a surface that is oriented at an angle of less than 90° relative to a plane parallel to said support, and (iii) a membrane sandwiched between said pneumatic layer and said fluidic layer, wherein said membrane is configured to actuate upon application of said positive or negative pressure from said pneumatic layer, wherein upon actuation, said membrane is deflected towards or away from said fluidic layer, to thereby subject fluid to movement to or from said fluidic channel.

74. The microfluidic device of claim 73, wherein said membrane comprises at least two polymeric layers.

75. The microfluidic device of claim 74, wherein said at least two polymeric layers are formed of different polymeric materials.

76. The microfluidic device of claim 74, wherein said at least two polymeric layers are separated from one another.

77. The microfluidic device of claim 74, wherein said at least two polymeric layers comprise a first polymeric layer formed of polydimethylsiloxane (PDMS) and a second polymeric layer formed of polytetrafluoroethylene (PTFE), fluorinated ethylene propylene (FEP), perfluoroalkoxy alkane (PFA), polyethylenetetrafluoroethylene (ETFE), polyethylenechlorotrifluoroethylene (ECTFE), polychlorotrifluoroethylene (PCTFE), a copolymer of hexafluoropropylene and tetrafluoroethylene, poly(methyl methacrylate) (PMMA), polydimethylsiloxane (PDMS), cyclic olefin copolymer (COC), polystyrene (PS), or combinations thereof.

78. The microfluidic device of claim 73, wherein said fluidic channel has a depth between about 1 micron (μm) and about 1,000 μm.

79. The microfluidic device of claim 73, wherein said fluidic channel has a depth of more than 10 μm.

80. The microfluidic device of claim 73, wherein said fluidic channel has a width that is at least 2 times a depth of said fluidic channel.

81. The microfluidic device of claim 73, wherein said valve remains in an open configuration in the absence of said supply of said positive or negative pressure.

82. The microfluidic device of claim 73, wherein said valve remains in a closed configuration in the absence of said supply of said positive or negative pressure.

83. The microfluidic device of claim 73, wherein said microfluidic device comprises a plurality of valves.

84. The microfluidic device of claim 83, wherein said plurality of valves comprises zero dead-volume valves.

85. The microfluidic device of claim 83, wherein said plurality of valves is actuated in a pre-defined sequence to regulate a fluid flow through said fluidic channel.

86. The microfluidic device of claim 83, wherein each of said plurality of valves is independently actuatable by a different pneumatic channel.

87. The microfluidic device of claim 86, wherein each of said independent actuation of said plurality of valves is directed by a computer system operably coupled to said microfluidic device, and wherein said computer system is operatively coupled to a computer network.

88. The microfluidic device of claim 73, wherein said microfluidic device comprises a plurality of fluidic channels.

89. The microfluidic device of claim 88, wherein a fluidic flow in each of said plurality of fluidic channels is independently regulated.

90. The microfluidic device of claim 73, wherein said microfluidic device is monolithic.

91. A method for directing a fluid flow, comprising:
(a) providing a microfluidic device comprising a fluidic channel, and a valve in fluidic communication with said fluidic channel, wherein said valve comprises (i) a pneumatic layer configured to supply a positive or negative pressure, (ii) a fluidic layer coupled to a support, wherein said fluidic layer comprises a surface that is oriented at an angle of less than 90° relative to a plane parallel to said support, and (iii) a membrane sandwiched between said pneumatic layer and said fluidic layer; and
(b) applying said positive or negative pressure from said pneumatic layer to said membrane to deflect said membrane towards or away from said fluidic layer, thereby subjecting fluid to movement to or from said fluidic channel.

92. A method for operating a microfluidic device, comprising:
(a) providing said microfluidic device comprising a valve comprising an actuation layer, a fluidic layer in fluid communication with a fluidic channel, and a membrane between said actuation layer and said fluidic layer, wherein said membrane comprises at least two polymeric layers; and
(b) actuating said membrane to cause said membrane to move towards or away from a surface of said fluidic layer, to permit fluid flow through said fluidic channel when said membrane is disposed away from said surface, or impede fluid flow in said fluidic channel when said membrane is in contact with said surface.
